(19) United States
(12) Patent Application Publication
(10) Pub. No.: US 2024/0271722 A1
(43) Pub. Date: Aug. 15, 2024

(54) SYSTEM FOR SUPPORTING A MOVABLE LINE-HOLDING DEVICE, ENERGY CHAIN OR THE LIKE

(71) Applicant: IGUS GMBH, Koeln (DE)

(72) Inventors: Dominik BARTEN, Meckenheim (DE); Andreas HERMEY, Hennef (DE); Thilo-Alexander JAEKER, Sankt Augustin (DE)

(21) Appl. No.: 18/681,109

(22) PCT Filed: Aug. 8, 2022
(86) PCT No.: PCT/EP2022/072265

§ 371 Date: Feb. 5, 2024

(30) Foreign Application Priority Data
Aug. 6, 2021 (DE) 20 2021 104 228.1

(51) Int. Cl. F16L 3/01

(52) U.S. Cl. CPC F16L 3/01

(57) ABSTRACT

A system for supporting an upper run of a movable line-holding device, more particularly an energy chain, the upper run running above a lower run during movement. The system comprises at least one supporting apparatus, which comprises a supporting element for supporting the upper run. The supporting element is transferred between a supporting position, in which the supporting element can act as a support of the upper run from below, and an evading position, in which the supporting element cannot act as a support.

### FIELD

The invention relates in general to the field of dynamic line guide apparatuses, in particular energy guide chains. The invention relates in particular to a system for supporting an upper run of a mobile line-receiving apparatus, in particular an energy guide chain.

A line-receiving apparatus of the type in question, in particular energy guide chain, is typically used for dynamically guiding at least one line, such as for example a cable, hose or the like, between a first connection point at a fixed point and a second connection point at a moving end which is mobile relative thereto. The line-receiving apparatus typically has the upper run, and a lower run connectable to the first connection point, the upper run usually being connectable to the second connection point. The upper run and the lower run are typically connected to one another via a displaceable deflection arc and the line-receiving apparatus is displaceable along a travel path. On displacement, the upper run typically runs above the lower run. The system has at least one support device which comprises a support element for supporting the upper run from below. The support element has a support body with a sliding surface and/or a support roller with a running surface. The support element is displaceable between a supporting position, in which the support element can act as a support for the upper run from below, and a retracted position, in which the support element cannot act as a support for the upper run from below.

### BACKGROUND

Such a system is already known. One challenge with these systems is that the support of the upper run from below should be designed such that it interferes as little as possible with the passage of the deflection arc when the line-receiving apparatus is moved back and forth.

One known system of the type in question is disclosed, for example, by U.S. Pat. No. 4,129,277 A1. In order to create a particularly simple system and to increase the self-supporting range of the line-receiving apparatus, the disclosed device has L-shaped supports with one long leg and one short leg which are arranged swivelably about an axis transversely of the longitudinal direction of the line-receiving apparatus in the region of the transition between the two legs. At the free ends of the long legs, rollers are mounted on the side facing the respective short leg which have a running surface for supporting the upper run of the line-receiving apparatus and, on the side facing the long leg, a flange part for lateral guidance of the upper run. From an outwardly tilted position of the L-shaped supports, in which they do not hinder movement of the line-receiving apparatus between them, the supports are brought upright by the lower run resting on the short legs pointing toward one another into a position in which the rollers can act to support and guide the upper run.

EP 2 419 981 B1 likewise discloses a system of the type in question. EP 2 419 981 B1 also discloses a spring support device. In this document, a switch body with inclined contact surfaces ensures that a roller is displaced out of the travel path of the line-receiving apparatus and the deflection arc thereof when it comes into contact with internal or external regions of the deflection arc, while return displacement is effected by way of spring force and weight force. This system and this spring support device have proven to be highly effective, in particular in an abrasive environment. For example, preventing the runs from sliding against one another ensures that chips do not get stuck between the runs. A drawback of this system and this spring support device is that they are not as suitable for certain environments and applications as might be desired.

DE 2362463 A1 describes another system for guiding energy guide chains. DE 2362463 A1 describes a system in which the stationary run is supported by chain grippers along its self-supporting length. The chain grippers are controlled or actuated by the energy guide chain itself. The changeover between supporting and retracted positions of the chain grippers is in particular controlled by pushbuttons and/or switches which are mechanically actuated by touching the energy guide chain.

A first object of the present invention is to propose a solution for a system, for an arrangement with a system and a line-receiving apparatus and for use of the system or arrangement which are improved with regard to at least one of the stated drawbacks or a wider range of applications.

### SUMMARY

The object is achieved according to the invention simply by the support device comprising an active displacement device which has at least one or precisely one controllable actuator. The displacement device, in particular the actuator, is used to displace the support element from the supporting position into the retracted position and/or vice versa, at least in one of the two directions. Furthermore, a coupling apparatus is in particular provided which couples the actuator with the support element, in particular mechanically, for the purpose of actuation or displacement. Furthermore, the system according to the invention can in particular have at least one sensor device which interacts contactlessly with the line-receiving apparatus, in particular for identifying the presence or absence of the deflection arc and/or lower run. The system can further be configured to control the actuator as a function of sensor signals from the at least one contactlessly acting sensor device, to which end various practical implementations can be considered.

As a result, the system is also usable inter alia in particularly clean environments, in particular in clean rooms, or in applications where it is particularly important to avoid abrasion caused by the system. The combination of active actuation or displacement of the support elements with a contactless sensor system is particularly advantageous. This ensures that the support elements do not have to be adjusted by physical contact with the line-receiving apparatus or energy guide chain at each support device. In contrast with various solutions known from the above-stated prior art, any wear due to friction during adjustment and/or actuation is thus avoided.

The system preferably has no surfaces that slide against one another.

When operating as intended with a functioning active displacement device, the system preferably prevents the line-receiving apparatus, or in particular the deflection arc, from bringing about the displacement of the support element by way of surfaces which slide against one another. In addition, the system according to the invention has been found to be particularly suitable for use in applications with intentionally very fast-moving line-receiving apparatuses, for instance faster than 5 m/s or 10 m/s or 15 m/s.

The term “displace” here means in particular movement from one location to another location, the type of movement not being critical. The displacement may for example take the form of swiveling or rotational motion, translational motion or indeed combined translational-rotational motion. The property “displaceable” is thus in the present case in particular generally taken to mean mobile or adjustable or positionable.

It is in principle conceivable for the support device to comprise a plurality of support elements. Preferably, however, the support device comprises precisely one support element.

The sliding surface and/or running surface preferably face(s) upward and is/are in particular freely accessible from above.

The line-receiving apparatus is in particular an intentionally mobile apparatus for dynamically guiding lines, hoses or the like.

The line-receiving apparatus may in particular but not necessarily be an energy guide chain for receiving lines, hoses or the like, in which adjacent links are connected together in articulated manner. The line-receiving apparatus may also for example be a band chain, in which the links are connected together by a flexible band, or another apparatus bendable in at least one plane for receiving lines. Other, non-link-type line-receiving apparatuses may also be considered, for example of the design according to WO 2016/042134 A1.

The term “retracted position” in the present case in particular means a position of the support element in which the deflection arc can travel past the support element. In the retracted position, the support element preferably does not protrude into the travel path of the line-receiving apparatus and the deflection arc thereof.

The support element preferably does not support the upper run permanently, but only intermittently.

The line-receiving apparatus preferably has one run which is stationary and one which is mobile and the lower run is preferably the stationary one and the upper run is preferably the mobile one.

The support element preferably comprises or is a support roller for reducing friction which is preferably rotatable about a horizontal axis of rotation.

If the support element has a support body with a sliding surface, the sliding surface may have a horizontally extending flattened portion or be formed thereby. In order to prevent the line-receiving apparatus from snagging on the sliding surface as it slides thereover, run-on bevels, which may be bent about a horizontal axis relative to the sliding surface, may be arranged on the sliding surface.

Each support element is preferably associated with its own actuator.

In one embodiment, the actuator is controllable using a plant or machine controller which is at a higher level than the system, for example a PLC (“programmable logic controller”), for instance on the basis of information about the position of the moving end. The plant or machine controller here denotes that controller which controls the movement of the mobile line-receiving apparatus, for example indirectly, by controlling the movement of the moving end, and therefore inherently has information about the instantaneous spatial position or current position thereof. This puts one of the conditions in place for the system to be able to operate without its own control unit and/or own sensors.

In a preferred embodiment, however, the system itself comprises at least one control unit for controlling the actuator as a function of the sensor signals from the at least one sensor device. This puts one of the conditions in place for the system, as preferred, to be self-contained, i.e., not dependent on sensor and/or control signals from a higher-level machine controller.

It is conceivable for the system to have precisely one control unit.

It is also conceivable for the system to have a higher-level, common control unit.

The control unit can interact with a plurality of actuators which are connected for signaling to the common control unit, for example via a bus.

Each support unit is, however, preferably associated with its own control unit. Precisely one control unit thus preferably interacts with precisely one support unit. Each actuator is particularly preferably associated with its own control unit. Precisely one control unit thus preferably interacts with precisely one actuator.

The actuator preferably has an input for receiving control signals and this input is connectable or connected to the control unit.

The system preferably has at least one sensor device, preferably for detecting the instantaneous location of the mobile line-receiving apparatus during operation. If the system has at least one sensor device, this puts one of the conditions in place for the system, as preferred, to be self-contained, i.e., not dependent on sensor and/or control signals from a higher-level machine controller. The system may thus preferably be of autonomous design, which facilitates retrofitting in existing applications.

The sensor device is preferably used to establish the position of the deflection arc and/or lower run. The system may comprise at least two or more sensor devices.

The control unit preferably comprises an evaluation unit which is preferably configured to evaluate the signals received from the at least one sensor or sensors.

The system is preferably autonomous or configured to be self-contained or operated in self-contained manner, in particular independently of sensor and/or control signals from the higher-level plant or machine controller. Each data or signal input of components of the system, for instance of the actuator, is preferably connected or connectable to a component of the system, for instance a control unit of the system.

The control unit or the evaluation unit thereof preferably has at least one input which is operatively connected to at least one of the at least one sensor devices. The term “operatively connected” in particular means a connection using an electrical line, for instance a signal line and/or by radio.

The control unit preferably has at least one output which is operatively connected to at least one of the at least one controllable actuators.

In the case of a plurality of sensors and in particular in the embodiment with a central or common control unit, each of the sensors can be wired for communication via a bus, for example field bus, preferably using linear (serial) topology and in particular two-wire technology, such as for example ASI bus or CAN bus with the evaluation unit or one or more interposed bus interface modules, bus couplers or the like. Other bus types, for example according to the IEC 61158 standard, such as Interbus or Profibus, may also be considered. In particular in the case of serial two-wire technology, cabling effort can be kept as low as possible. The sensors are preferably supplied electrically with energy via the bus. A wireless interface, such as WiFi, via which the sensors communicate with the evaluation unit is also conceivable. The wireless variant can particularly simplify on-site installation of the system. The sensors can be distributed along one side, or alternatively on both sides of the line-receiving apparatus, e.g. in pairs or alternatingly.

In particular in the embodiment in which each actuator is associated with its own control unit, the control unit preferably in each case interacts with two sensor devices. This can put one of the conditions in place for a simple yet reliable system, and a bus can be dispensed with. This facilitates installation, in particular retrofitting existing applications.

The control unit preferably interacts in each case with precisely two sensor devices which are arranged on different sides of an at least approximately vertical plane. This vertical plane is preferably arranged such that the direction of displacement of the support element, which is displaced by the actuator associated with the control unit, is located within said plane. In the context of the present document, the phrase “direction of displacement of the support element” in particular means the direction of movement of this element between its supporting position and its retracted position. In the embodiment in which the support element comprises a support roller, this vertical plane is preferably arranged such that the axis of rotation of the support roller of the support element, which is displaced by the actuator associated with the control unit, is located within said plane.

The distance of the sensor device from the support element is preferably selected as a function of the traveling speed of the line-receiving apparatus. The distance of the sensor device from the support element is selected to be greater in applications with line-receiving apparatuses which are intended to move very quickly, for example faster than 5 m/s or 10 m/s or 15 m/s, than in applications with line-receiving apparatuses which are not intended to move very quickly.

The distance of the sensor device from the support element is preferably less than half the distance between two adjacent support units.

The control unit can in each case interact with at least two sensor devices, in particular with precisely two sensor devices, for each support element. The control unit can in each case interact with precisely one sensor device arranged on the side of the support element facing away from the first connection point and with precisely one sensor device arranged on the side of the support element facing toward the first connection point.

The sensor device preferably comprises a sensor, wherein the sensor has a detection range. The sensor preferably detects the presence or absence of the line-receiving apparatus, in particular of the lower run in its detection range. The sensor device preferably comprises a single sensor, or detector or the like. In addition to the detector, the sensor device may comprise an emitter and/or a reflector. Alternatively, it can be formed from precisely one sensor. The sensor device can be configured to detect the position of at least one portion of the line-receiving apparatus in relation to a travel path in the longitudinal direction of the line-receiving apparatus. It is conceivable for the sensor devices to form a detection zone along the travel path. The at least one sensor device can for example detect the position of the deflection arc or provide data and/or signals for the detection thereof. Alternatively, a sensor device can detect the position of the mobile end of the line-receiving apparatus. A sensor device can in particular detect a change in the direction of travel of the mobile end of the line-receiving apparatus.

The, or each, sensor device preferably acts contactlessly, in particular thus without physical contact with the line-receiving apparatus. The sensor device may for example comprise or be formed by a proximity switch. The sensor device may comprise an optical proximity switch, preferably light scanner, i.e., an optical sensor, in which the emitter and detector is integrated in one unit and preferably no reflector is necessary on the object to be detected. Throughbeam photoelectric sensors with a detector separate from the emitter or retroflective photoelectric sensors with an additional reflector may also be considered as optical proximity switches. One conceivable alternative to these are capacitive proximity switches which can interact contactlessly with the line-receiving apparatus. Other contactless proximity switches, such as for example inductive proximity switches, reed switching contacts or Hall-effect sensors etc. are also within the scope of the invention.

In one embodiment, the sensor device can act by direct or indirect physical contact. The device, for example, here comprises a pressure sensor for detecting the weight force of the line-receiving apparatus. The sensor device preferably interacts exclusively with the lower run.

If an assembly is provided which comprises a control unit and two sensor devices, and a support device with a support element and an actuator, and the control unit is configured such that it controls the actuator exclusively as a function of the signals from the two sensor devices, this puts one of the conditions in place for a modular system which is particularly simple to adapt to different lengths of line-receiving apparatuses and can be straightforwardly repairable by replacing the assembly in the event of a fault. In addition, this again puts one of the conditions in place for the system, as preferred, to be self-contained, i.e., not dependent on sensor and/or control signals from a higher-level machine controller. The sensor devices of the assembly are preferably located opposite one another relative to an at least approximately vertical plane. The vertical plane is preferably arranged such that the direction of displacement of the support element of the assembly and/or the axis of rotation of the support roller of the support element of the assembly is located therein.

The actuator preferably brings about a movement and more preferably comprises an electrical rotary motor. The electrical rotary motor may comprise a stepping motor or a servomotor. Alternatively, the actuator may comprise an electronic solenoid or an electrical linear motor. A pneumatic lift drive or the like is also conceivable.

The support device preferably has a load-bearing structure for absorbing forces applied vertically downward from above, in particular by the upper run, onto the sliding surface and/or running surface. These forces are preferably the weight force of the upper run.

The support device, in particular the load-bearing structure, may have a guide wall which can laterally guide the line-receiving apparatus and can take the form of a side wall. The guide wall can extend parallel to the direction of travel of the line-receiving apparatus. The guide wall is preferably of vertically fixed construction. At least in the supporting position of the support element, the axis of rotation of the associated support roller preferably extends perpendicular to the guide wall. At least in the retracted position of the support element, the axis of rotation of the associated support roller preferably extends obliquely to the guide wall.

The guide wall may have a guide surface for bearing against lateral regions of the upper run and/or lower run for lateral guidance in particular of the upper run of the line-receiving apparatus. The guide surface may take the form of a side surface. The guide wall may be of plate-shaped configuration. The guide wall may include an opening for the support element.

Two preferably plate-shaped support walls which are bent relative to the guide wall can be arranged on the guide wall. The support walls can be arranged to the side of the opening and extend transversely of the direction of travel of the line-receiving apparatus. The guide wall can extend between the support walls. The guide wall can merge via inclined or curved regions into the support walls.

The guide wall can form an approximately U-shaped horizontal cross-section with the support walls and the control unit and/or actuator can be arranged within this U-shaped cross-section. Configuration as a U-shaped cross-section can increase the stability of the support device and arranging the actuator and/or control unit in the interior of this cross-section can effectively protect it/them from external influences while nevertheless providing ready access.

The support device preferably comprises at least one swivel arm swivelably mounted by way of a pivot bearing. The support element is further preferably arranged on the swivel arm. The support element can be arranged on the swivel arm directly, or indirectly, for instance by way of a holder. The holder may have a plate-shaped region.

The swivel arm can be part of the load-bearing structure, i.e., it can absorb forces applied vertically downward from above, in particular by the upper run, onto the sliding surface and/or running surface.

The swivel arm can be mounted below the support element. The swivel arm can be part of or form the coupling apparatus. The pivot bearing can be arranged on the support walls.

Each support device preferably has two swivel arms and the support element is arranged on the two swivel arms, preferably between the two swivel arms.

If the pivot bearing comprises a rolling bearing, the system's suitability for particularly clean surroundings, where it is particularly important to avoid abrasion caused by the system, can be further increased. The rolling bearing can take the form of a ball bearing.

When in the supporting position, the support element and/or the holder by way of which the support element is arranged on the swivel arm can extend through the opening of the guide wall of the support device.

The jamb of the opening can provide a limit stop for the support element and/or the holder and/or the at least one swivel arm which defines the supporting position of the support element. The limit stop can limit the swivel angle of the at least one swivel arm.

The active displacement device preferably comprises a spring element which acts contrary to the direction of a movement brought about by the actuator.

In this way, an actuator which converts energy into movement in precisely one linear direction or precisely one direction of rotation can particularly reliably be put to use. Actuator control can additionally be simplified.

The spring element preferably comprises or is formed by a tension spring.

The spring element preferably comprises or is formed by a helical spring.

Configuring the spring element of the support device as a tension spring or helical spring and not, for instance, as a bar bending spring supported slidingly along a wall as in EP 2 419 981 B1, in particular has the advantage of avoiding or preventing abrasion.

The spring element preferably acts between a spring bearing of the support device and the swivel arm or a further swivel arm which is firmly connected to the swivel arm. The swivel arm and the further swivel arm can together form an angle lever. The spring bearing can be arranged on the support wall or guide wall or the bottom of the support device. The further swivel arm preferably provides a lever projection to create a leverage effect for the spring element. The spring bearing may comprise or be formed by a projection. The spring bearing may comprise or be formed by a hole, for instance in the load-bearing structure. The spring element can be hooked into the spring bearing. Spring contact surfaces for transmitting the spring force are preferably provided on the spring bearing and on the swivel arm or further swivel arm. The spring contact surfaces preferably take the form of static friction surfaces and/or rolling friction surfaces. Abrasion can be reduced by static friction and/or rolling friction, but not sliding friction, preferably occurring on the spring contact surfaces. The support device preferably has two swivel arms. In the embodiment in which the support device comprises two swivel arms, it may have two spring elements or just one spring element. Particular system reliability can be achieved if a passive displacement device is provided in addition to the active displacement device. The support device preferably comprises the passive displacement device. The passive displacement device can make use of components of the active displacement device. The passive displacement device preferably ensures movement of the support element between the supporting position and the retracted position even in the event of at least partial failure of the active displacement device, for instance due to a sensor fault.

The passive displacement device preferably comprises a switching device, preferably in the form of a switch body, which can be moved into the travel path of the line-receiving apparatus. The switch body can have run-on surfaces, in particular run-on bevels, preferably two opposing ones which can preferably interact with the deflection arc, in particular in the event of failure of the active displacement device, by contact with inner and outer regions of the deflection arc in order to move the switch body out of the travel path of the line-receiving apparatus. The switch body is preferably coupled to the support element in such a way that the latter is displaced from its supporting position into the retracted position when the switch body is moved out of the travel path of the line-receiving apparatus. In a preferred embodiment, the switch body is movable into the travel path of the line-receiving apparatus under the effect of gravity and/or by spring force and is preferably coupled to the support element in such a way that the latter is displaced from its retracted position into the supporting position. The support element is preferably arranged on the switching device. This results in a simple design which creates the coupling between the switch and support elements. The switch body can take the form of a housing arranged in part around the circumference of the support roller. The housing can be open in the region of an front face of the roller and protrude beyond this front face.

The switch body is preferably swivelably mounted about a swivel axis, preferably outside the inner side surface of the guide wall in question and more preferably on the same swivel arm or swivel arms as the support element.

The center of gravity of the switch body, in particular in the position which the switch body occupies when the support element is in its retracted position, is preferably located in such a way relative to the swivel axis that the switch body is pivoted under its weight alone and/or with optional spring force assistance into the travel path of the line-receiving apparatus if it is not contacted by the line-receiving apparatus.

The spring force is preferably provided by a spring element which may comprise a tension spring which may take the form of a helical spring.

The spring force can be provided by the same spring element which acts contrary to the direction of a movement produced by the actuator and/or to the direction of displacement of the support element.

It is in principle conceivable for the system to comprise just one support device. The system preferably comprises a plurality of support devices.

The system preferably comprises at least one support unit. The support unit preferably comprises precisely two opposing support devices. The support devices of the support unit are preferably arranged opposite one another in such a way that, on displacement from the retracted position into the supporting position, the support elements thereof move toward one another. The support devices of the support unit are preferably connected together, preferably by a bottom crosspiece. The support unit is preferably U-shaped in vertical section. The support unit may have two opposing, vertically fixed guide walls in the form of side walls with internal side surfaces for bearing against lateral regions of the two runs. The swivel arm can be swivelably mounted outside the internal side surface of the guide wall in question. In the supporting position, the support element preferably protrudes into the interior of the support unit opposite the side surface. In the retracted position, the support element preferably does not protrude significantly beyond the inner side surface of the guide wall in question. The bottom crosspiece may have on its upper side a resting surface for the lower run of the line-receiving apparatus.

It is, in principle, conceivable for the system to comprise just precisely one support unit. At least two support units are preferably provided. The support units are preferably spaced apart from one another in a longitudinal direction of the system. The longitudinal direction of the system preferably corresponds to the longitudinal direction of the line-receiving apparatus.

In the preferred embodiment, the system comprises, preferably in the region in which the lower run of the line-receiving apparatus can be set down, two opposing side guide parts between which at least one of the runs can be received. The two opposing side guide parts preferably extend from one support unit to another support unit. The two opposing side guide parts preferably connect the at least two support units to one another.

The side guide part preferably in each case comprises legs arranged in an L-shape. One leg can extend along the inside of the side walls and the other leg can extend perpendicular to the side walls into the interior of the support unit and form lateral guides or resting surfaces for the lower run of the line-receiving apparatus.

The two opposing side guide parts can also together be designated “guide channel”. A bottom region which connects the two opposing side guide parts to one another, for example in one piece, can be provided.

In the embodiment in which the system comprises at least one sensor device, the latter is preferably arranged on at least one side guide part. This makes it possible to dispense with separate sensor positioning means and a distance can be established particularly simply between the sensor device and the associated control unit or the associated support element in order to provide the control unit and the actuator with sufficient time to move the support element.

The longitudinal extent of the side guide parts preferably extends in the longitudinal direction of the system.

Each support unit preferably comprises two support elements. Each support unit preferably comprises two actuators, each of which is more preferably associated with precisely one control unit. Precisely two sensor devices can be operatively connected to each of these two control units of a support unit, wherein these two sensor devices can be operatively connected to precisely one control unit or to each of these two control units. It is alternatively conceivable for four sensor devices, which can be located opposite one another in pairs, to be operatively connected to each of these two control units. Since the signals from opposing sensor devices should be identical, they can be used by the control unit for plausibility checks or as redundancy in the event of a sensor device fault. It is additionally conceivable to associate the two actuators of a support unit with a common control unit. For example, precisely two or precisely four sensor devices can be operatively connected to this common control unit.

The arrangement according to the invention comprises a system and a line-receiving apparatus.

The line-receiving apparatus of the arrangement preferably comprises an energy guide chain for guiding lines, such as for example cables or hoses. The energy guide chain preferably has two parallel strings of plates, wherein each string of plates preferably comprises side plates which are particularly preferably connected to one another and bendable relative to one another by way of a flexible joint connector. Alternatively, the line-receiving apparatus comprises a band chain, in which links or regions are connected to one another via flexible band.

The energy guide chain or band chain is preferably certified for cleanroom applications, preferably to DIN EN ISO 14644-1 ISO, preferably in the version valid on the filing date of this document and very particularly preferably to ISO class 1 to ISO class 5. The flexible joint connector is preferably elastically deformable in the bending direction of the side plates.

The arrangement is particularly suitable for use in clean surroundings, for instance in a clean room. The arrangement is also particularly suitable for use in surroundings requiring particular peace and quiet or when only low levels of friction loss associated with displacement of the line-receiving apparatus are tolerable.

In the embodiment in which the support element of the system of the arrangement takes the form of a support roller, the arrangement preferably has no surfaces which slide over one another.

The line-receiving apparatus preferably travels at a speed of more than 5 m/s or 10 m/s or 15 m/s.

In this use, one sensor device is preferably arranged on the side of the support element facing away from the first connection point and another sensor device is arranged on the side of the support element facing toward the first connection point.

The signals from the two sensor devices are preferably each evaluated as to whether the associated sensor device indicates the presence or absence of the lower run.

The support element is preferably displaced from its supporting position into its retracted position when one of the two sensor devices indicates the presence of the lower run and the other of the two sensor devices indicates the absence of the lower run and the signals from the two sensor devices thus do not match.

The support element is preferably displaced from its retracted position into its supporting position when both sensor devices indicate the presence or absence of the lower run and the signals from the two sensor devices thus match. Use can be based on a single signal comparison and therefore be particularly simple and reliable to carry out.

The support element can be moved from its supporting position into its retracted position and/or vice versa by driving the associated actuator. The support element can be moved from its supporting position into its retracted position or vice versa by spring force.

In order to move the support element from its supporting position into its retracted position, the associated actuator can be driven by the control unit by being supplied with, preferably electrical, energy. It is alternatively conceivable for the associated actuator to be driven for this purpose by the control unit by a supply of, preferably electrical, energy to the associated actuator being interrupted, such that the actuator allows the support element to be displaced from its supporting position into its retracted position by way of weight force and/or spring force.

In order to move the support element from its retracted position into its supporting position, the associated actuator can be driven by the control unit by a supply of electrical energy to the associated actuator being interrupted, such that the actuator allows the support element to be displaced from its retracted position into its supporting position by way of weight force and/or spring force. It is alternatively conceivable for the associated actuator to be driven for this purpose by the control unit by being supplied with, preferably electrical, energy.

The advantages of the invention are particularly apparent if the line-receiving apparatus is clean room certified or is displaced at a speed of more than 5 m/s or 10 m/s or 15 m/s.

The arrangement is preferably operated in self-contained manner, i.e., independently of sensor and/or control signals from a higher-level machine controller.

A second object of the present invention is to propose a solution for a spring support device which is improved with regard to at least one of the above-mentioned drawbacks or a wider range of applications.

This object is achieved by the spring support device. The spring support device according to the invention is used to support an upper run of a line-receiving apparatus, in particular an energy guide chain. The spring support device comprises a support element for supporting the upper run from below and at least one swivel arm on which the support element is indirectly or directly arranged, wherein the support element is displaceable between a supporting position, in which the support element can act as a support for the upper run from below, and a retracted position, in which the support element cannot act as a support for the upper run from below. The spring support device has a passive displacement device which comprises a switching device in the form of a switch body which is movable by way of spring force into the travel path of the line-receiving apparatus. The spring force is provided by a spring element in the form of a helical spring which acts between a spring bearing of the spring support device and the swivel arm or a further swivel arm which is firmly connected to the swivel arm. The further swivel arm preferably provides a lever projection to create a leverage effect for the spring element. The spring bearing can be arranged on the support wall or guide wall or the bottom of the spring support device. The spring bearing may comprise or be formed by a projection. The spring bearing can comprise or be formed by a hole, for instance in the load-bearing structure. The spring element can be hooked into the spring bearing. Spring contact surfaces for transmitting the spring force are preferably provided on the spring bearing and on the swivel arm or further swivel arm. The spring contact surfaces preferably take the form of static friction surfaces and/or rolling friction surfaces. Abrasion can be reduced by static friction and/or rolling friction, but not sliding friction, preferably occurring on the spring contact surfaces.

The spring support device can be designed in the same way as the support device described above. The spring support device can be provided with or without an active displacement device. The swivel arm and the further swivel arm can together form an angle lever.

Configuring the spring element of the spring support device as a helical spring and not, for instance, as a bar bending spring which slides along a wall as in EP 2 419 981 B1, in particular has the advantage of avoiding or preventing abrasion.

The spring support device is used for, preferably temporarily, supporting an upper run of a line-receiving apparatus.

The line-receiving apparatus, which has the upper run which the spring support device is used to support, is suitable for guiding at least one line, such as for example a cable, hose or the like, preferably between a first connection point at a fixed point and a second connection point at a moving end which is mobile relative thereto. The line-receiving apparatus can have the upper run, and a lower run connectable to the first connection point. The upper run can be connectable to the second connection point. The upper run and the lower run can be connected to one another via a displaceable deflection arc. The line-receiving apparatus is displaceable along a travel path. On displacement, the upper run can run above the lower run. The support element has a support body with a sliding surface and/or a support roller with a running surface.

The spring support device can have a load-bearing structure for absorbing forces applied vertically downward from above, in particular by the upper run, onto the sliding surface and/or the running surface.

The spring element can be arranged in an opening, which is accessible externally from the side, of the spring support device or the load-bearing structure for the purpose of simple replaceability in the event of a defect.

The load-bearing structure of the spring support device can comprise a guide wall and support walls which form a U-shape in horizontal cross-section with this guide wall. The spring element can be arranged within this U-shaped cross-section.

The spring support device preferably has two swivel arms. In the embodiment in which the spring support device comprises two swivel arms, it may have two spring elements or just one spring element.

The switch body of the switching device can in each case have two opposing run-on surfaces, in particular run-on bevels which can interact with the deflection arc in order to move the switch body out of the travel path of the line-receiving apparatus. The switch body of the switching device can be coupled to the support element of the spring support device in such a way that the support element is movable from its supporting position into the retracted position.

The switch body preferably has a vertical sliding surface for bearing against lateral regions of the upper run when the switch body has been moved out of the travel path of the line-receiving apparatus. When the switch body has been moved out of the travel path of the line-receiving apparatus, the vertical sliding surface is preferably arranged at least approximately vertically. The switch body preferably has a sliding bracket which is arranged on the vertical sliding surface. The sliding bracket can extend from one run-on bevel to the opposing run-on bevel. It can extend around the lower circumference of the support roller.

In the spring support device, the support element is preferably formed on the switching device which pivots the support element out of the retracted position into the supporting position. This results in a simple design which creates the coupling between the switch and support elements.

Two opposing spring support devices can be connected, for instance by way of a bottom crosspiece, to form a spring support unit.

The features of all aspects, i.e., in particular features of the system, the arrangement, the use and the spring support device are initially disclosed and claimed independently for the purposes of the invention but, as is apparent, can also be combined with one another. Accordingly, the features of the system can, insofar as compatible, also be advantageous for the spring support device and vice versa. All the features of the respective exemplary embodiment or the respective aspects and embodiments set out further above are mutually independently generally disclosed as features of the invention, in each case taken alone or in combination with one another, also in combination with features of other aspects, exemplary embodiments or embodiments.

### BRIEF DESCRIPTION OF THE DRAWINGS

Further details, advantages and features of the invention may, without limiting the general nature of the above description, be inferred from the following part of the description in which at least one exemplary embodiment is explained in greater detail with reference to the appended drawings, in which:

FIG. 1 shows a side view of a system 100 and an arrangement 200 with a line-receiving apparatus in the form of an energy guide chain in three possible displacement positions;

FIG. 2 shows a view in the longitudinal direction of the support unit depicted as the second from the right in FIG. 1, in which the support elements are in the supporting position, corresponding to the displacement position of the line-receiving apparatus depicted on the left and right in FIG. 1;

FIG. 3 shows a sectional representation along section line D-D in FIG. 1, corresponding to the displacement position of the line-receiving apparatus depicted centrally in FIG. 1;

FIG. 4 shows a view as in FIG. 1, with the displacement position of the line-receiving apparatus depicted on the left in FIG. 1;

FIG. 5 shows a view as in FIG. 1, with the displacement position of the line-receiving apparatus depicted centrally in FIG. 1;

FIG. 6 shows a view as in FIG. 1, with the displacement position of the line-receiving apparatus depicted on the right in FIG. 1;

FIG. 7 shows a sectional representation along section line A-A in FIG. 4;

FIG. 8 shows a sectional representation along section line B-B in FIG. 5;

FIG. 9 shows a sectional representation along section line C-C in FIG. 6;

FIG. 10 shows detail E from FIG. 4 on a larger scale;

FIG. 11 shows the support unit from FIG. 10 in the longitudinal direction;

FIG. 12 shows a perspective representation of the support unit from FIG. 10;

FIG. 13 shows part of FIG. 5 in a schematic diagram from above;

FIG. 14 shows a more detailed representation of detail F from FIG. 13;

FIG. 15 shows a flow chart of the use of system 100 and arrangement 200;

FIG. 16 shows the spring support device shown in detail F in FIG. 4 in a larger depiction as an exemplary embodiment of an independently claimed further aspect;

FIG. 17 shows another view of the spring support device from FIG. 16; and

FIG. 18 shows a perspective representation of the spring support device from FIG. 16.

### DETAILED DESCRIPTION

The exemplary embodiment of the system according to the invention shown in the figures is designated overall as 100.

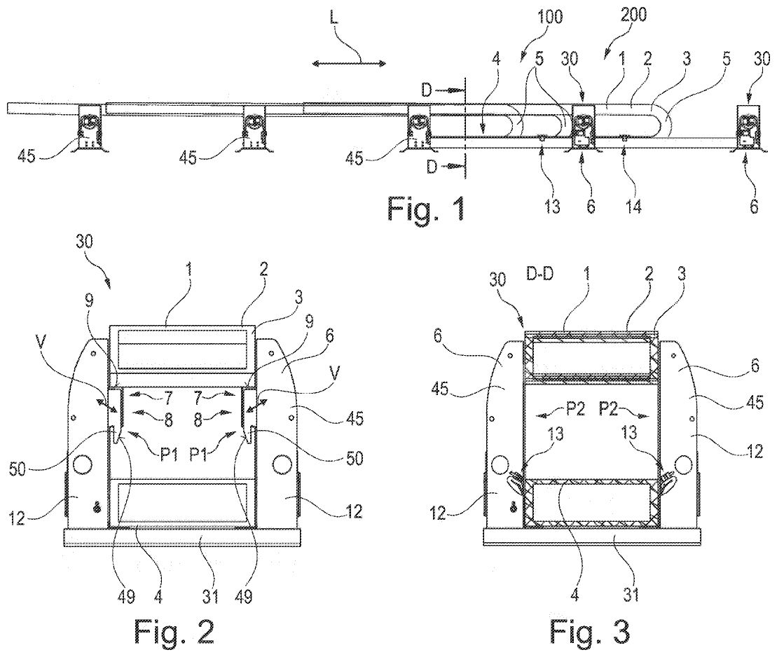

The system 100 is used to support an upper run 1 of a line-receiving apparatus 2 for guiding at least one line, such as for example a cable, hose or the like, between a first connection point at a fixed point and a second connection point at a moving end which is mobile relative thereto, wherein the line-receiving apparatus 2 has the upper run 1, and a lower run 4 connectable to the first connection point, the upper run 1 being connectable to the second connection point. The upper run 1 and lower run 4 are connected to one another, as is apparent for instance in FIG. 1, via a displaceable deflection arc 5. This figure also shows that the line-receiving apparatus 2 is displaceable along a travel path and, on displacement, the upper run 1 runs above the lower run 4. The upper run 1 and lower run 4 travel substantially horizontally.

In the exemplary embodiment shown, the system 100 has a plurality of, for example four, support devices 6. Each support device 6 comprises a support element 7 for temporarily supporting the upper run 1 from below, which support element is displaceable between a supporting position P1, in which it can act as a support for the upper run 1 from below, and a retracted position P2, in which it cannot act as a support for the upper run 1 from below.

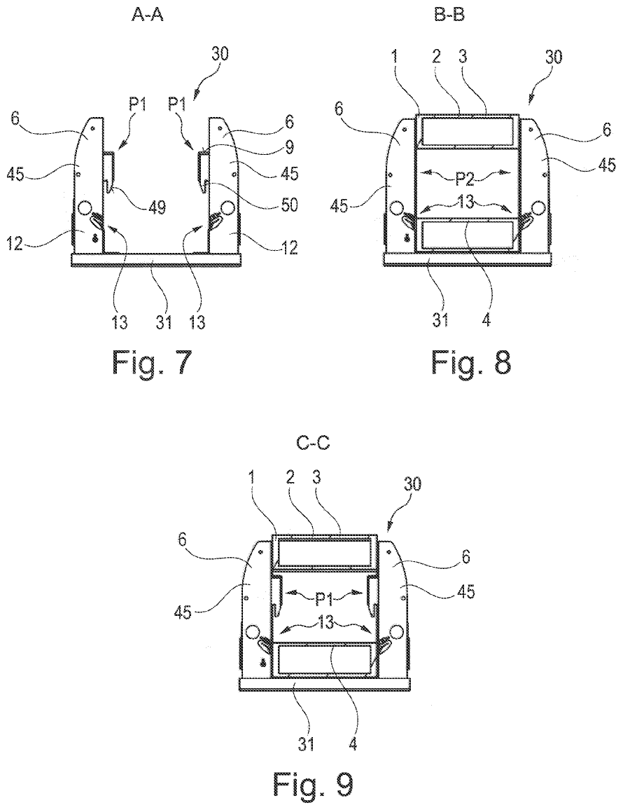

As for example a comparison of FIGS. 7 and 8 shows, in the retracted position P2 the support element 7 does not protrude into the travel path of the line-receiving apparatus 2 and its deflection arc. The deflection arc 5 can travel past the support element 7 without touching it when the support element 7 is in the retracted position P2.

Two support devices 6 are in each case paired and arranged opposite one another, specifically such that, on displacement from the retracted position P2 into the supporting position P1, their support elements 7 move toward one another (cf. FIG. 3 and FIG. 2). The two support devices 6 of a pair are in each case connected to one another by a bottom crosspiece 31 to form a support unit 30. Two corresponding support units 30, which are spaced apart from one another in the longitudinal direction L of the system 100, are shown on the right in FIG. 1.

As is most readily apparent in FIG. 12, in the exemplary embodiment shown the support element 7 has a support roller 8 which is rotatable about an axis of rotation 36 and has a running surface 9. The running surface 9 faces upward and is freely accessible from above.

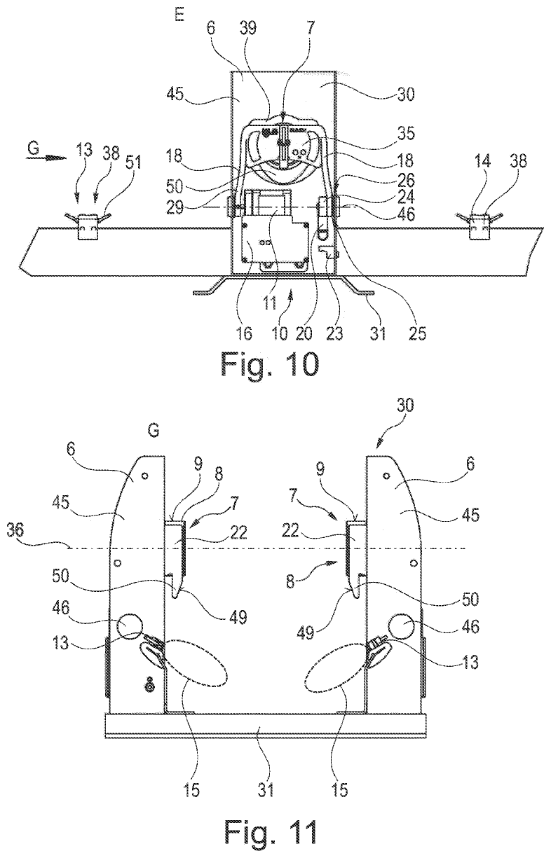

FIGS. 10 and 12 for example show that the support device 6 has an active displacement device 10, which in this case comprises precisely one controllable actuator 11, for displacing the support element 7 from the supporting position P1 into the retracted position P2. The coupling apparatus 29 which couples the actuator 11 to the support element 7 is also shown, for instance in FIG. 10. In the exemplary embodiment shown, the actuator 11 takes the form of an electrical rotary motor 33, specifically of a stepping motor.

In the exemplary embodiment shown, the line-receiving apparatus 2 is an energy guide chain 3 for receiving lines, hoses or the like. As not shown in the figures, adjacent links of the energy guide chain are connected together in an articulated manner and thus form a mobile line-receiving apparatus 2 or dynamic line guide. The longitudinal direction L of the system 100 corresponds to the longitudinal direction of the line-receiving apparatus 2.

The system 100 has a control unit 16 for controlling the actuator 11. In the example shown, each actuator 11 is associated with its own control unit 16. The system 100 additionally has at least one sensor device 13, 14 for determining the position of the deflection arc 5, wherein, in the example shown, precisely two sensor devices 13, 14 are operatively connected to each control unit 16. The sensor devices operatively connected to the control unit 16 of the support device 6 shown on the right in FIG. 1 are not shown for greater case of depiction.

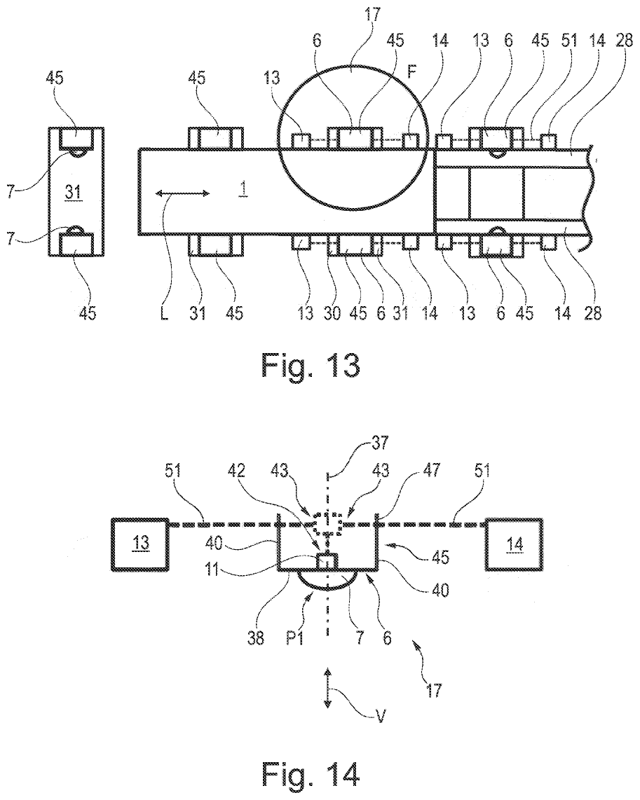

The control unit 16 in each case comprises an evaluation unit and its input is operatively connected to precisely two sensor devices 13, 14, in the exemplary embodiment shown via a signal line 51. For greater case of depiction, the signal lines 51 are only indicated in FIGS. 1 and 3 to 12. FIGS. 13 and 14 show the signal lines 51 as dashed lines. The output of each control unit 16 is in each case operatively connected to precisely one actuator 11.

As FIG. 12 and FIG. 14 show most clearly, the control unit 16 interacts in each case with precisely two sensor devices 13, 14 which are located opposite one another in relation to a vertical plane 37 containing the axis of rotation 36 of the support roller 8.

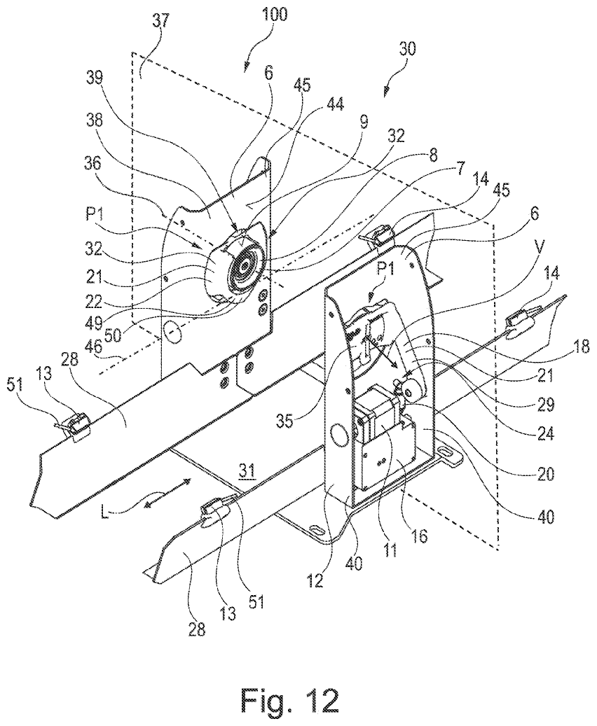

Each sensor device 13, 14 comprises a sensor 38 with a detection range 15 (FIGS. 10 and 11). The sensor 38 detects the presence or absence of the lower run 4 in its detection range 15.

The sensor device 13, 14, in particular the sensor 38, acts contactlessly and, in the exemplary embodiment shown, comprises a light scanner.

FIGS. 13 and 14 show that an assembly 17 is provided which comprises precisely one control unit 16 and precisely two sensor devices 13, 14 and precisely one support device 6 with precisely one support element 7 and precisely one actuator 11. As is apparent from FIG. 14, the control unit 16 is configured such that it can control the actuator 11 exclusively as a function of the signals from the two sensor devices 13, 14. In a fault scenario, the assembly 17 can thus easily be replaced or also easily retrofitted.

FIGS. 6 and 12 for example show that the support device 6 has a load-bearing structure 12 for absorbing forces applied vertically downward from above by the upper run 1 onto the running surface 9.

The support element 7 is arranged by way of a plate-shaped holder 35 on two swivel arms 18 (FIG. 12). The support device 6 has a vertically fixed guide wall 38 with an opening 39. In the supporting position P1, the support roller 8 extends through the opening 39. The jamb of the opening 39 provides a limit stop for the holder 35 and/or the at least one swivel arm 18 which defines the supporting position P1 of the support roller 8 by limiting the swivel angle of the two swivel arms 18.

Two plate-shaped support walls 40 which are bent relative to the guide wall 38 are arranged on the guide wall 38 and are produced for example in one piece as a formed sheet metal part with the guide wall 38.

FIGS. 12 and 14 also show that the guide wall 38 forms an approximately U-shaped horizontal cross-section with the support walls 40 and the control unit 16 and actuator 11 are arranged within this U-shaped cross-section.

The swivel arms 18 are part of the load-bearing structure 12 and thus serve to absorb forces applied vertically downward from above by the upper run 1 onto the running surface 9. The swivel arms 18 are in each case mounted by way of a pivot bearing 25 which takes the form of a ball bearing 26 and defines the swivel axis 46 of the swivel arms.

Thanks to the support rollers 8 and pivot bearings 25, the system 100 as far as possible avoids surfaces which slide on one another.

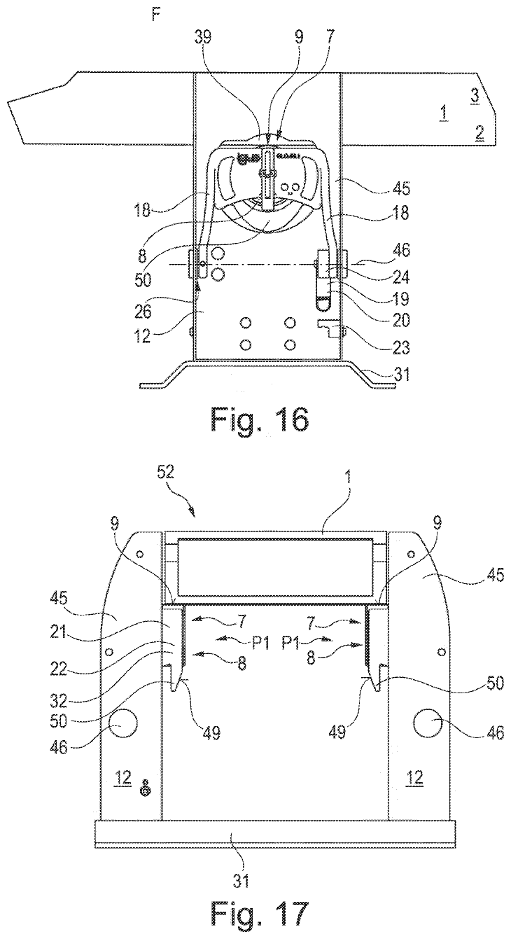

As FIGS. 10 and 12 again show, the active displacement device 10 furthermore comprises a spring element 19 in the form of a helical tension spring which acts contrary to the direction of a rotational movement generated by the actuator 11. The spring element 19 acts for this purpose between a spring bearing 23 (FIG. 10) and a further swivel arm 24 which is firmly connected to the swivel arm 18 and forms an angle lever. As is apparent for example in FIGS. 10 and 16, the spring bearing can be arranged on a support wall 40 of the support device 6. It can also be arranged on the guide wall 38 of the support device 6 or the bottom 48 of the support device. For greater case of illustration, the spring element is shown in the figures in a state in which it is not hooked into the spring bearing.

In addition to the above-described active displacement device 10, the system 100 thus has a passive displacement device 21 which uses components of the active displacement device. The passive displacement device 21 ensures movement of the support element 7 between the supporting position P1 and the retracted position P2 even if the active displacement device 10 fails, for instance due to a sensor fault or power failure.

The passive displacement device comprises a switching device in the form of a switch body 22 which can be moved into the travel path of the line-receiving apparatus 2. The switch body 22 has two mutually opposing run-on bevels 32 which can interact with the deflection arc 5 in the event of failure of the active displacement device 10 by contact with internal and external regions of the deflection arc in order to move the switch body 22 out of the travel path of the line-receiving apparatus 2. The switch body 22 is coupled to the support element 7 in such a way that the latter is displaced from its supporting position P1 into the retracted position P2 when the switch body is moved out of the travel path of the line-receiving apparatus. The switch body 22 is movable into the travel path of the line-receiving apparatus 2 under the effect of gravity and by spring force and coupled to the support element 7 such that the latter is displaced from its retracted position P2 into the supporting position P1.

The switch body 22 has a vertical sliding surface 49 for bearing against lateral regions of the upper run 1 when the switch body 22 has been moved out of the travel path of the line-receiving apparatus 2. When the switch body 22 has been moved out of the travel path of the line-receiving apparatus, the vertical sliding surface 49 is arranged vertically and arranged on a sliding bracket 50 extending from one run-on bevel 32 to the opposing run-on bevel 32. The sliding bracket 50 extends around the lower circumference of the support roller 8 (FIGS. 2, 12 & 16).

The switch body takes the form of a housing arranged around the circumference of the support roller 8 with the exception of running surface 9. The housing is open in the region of a front face of the support roller 8.

The spring force for passive return or displacement from the retracted position P2 into the supporting position P1 is provided by the same spring element 19 which acts contrary to the direction of a movement brought about by the actuator 11.

As shown for instance by FIGS. 1 and 12, the side guide parts 28 extend in the longitudinal direction L which, in the installed operational state, corresponds to the longitudinal direction of the line-receiving apparatus 2.

An exemplary embodiment of the arrangement designated overall as 200 is likewise shown for example in FIG. 1. The line-receiving apparatus 2 of the arrangement 200 comprises an energy guide chain 3 for guiding lines, such as for example cables or hoses. The energy guide chain 3, which is not shown in detail in the figures, has two parallel strings of plates, wherein each string of plates comprises side plates which are particularly preferably connected to one another and bendable relative to one another by way of a flexible joint connector. The flexible joint connector is elastically deformable in the bending direction of the side plates.

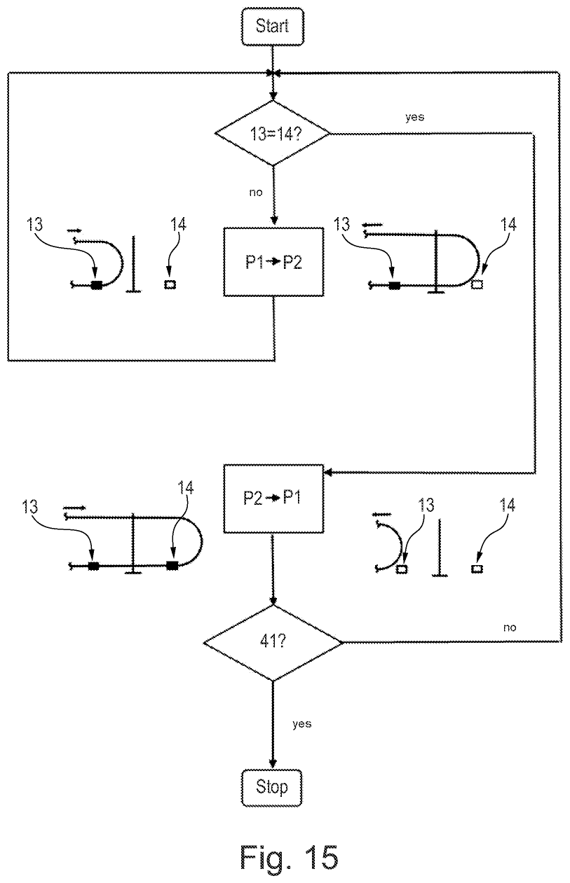

FIG. 15 shows a flow chart of the use or mode of operation of the system 100 and the arrangement 200. In this use or preferred mode of operation, a sensor device 14 is arranged on the side of the support element 7 facing away from the first connection point and another sensor device 13 is arranged on the side of the support element 7 facing toward the first connection point.

The signals from the two sensor devices 13, 14 are in each case evaluated as to whether the associated sensor device 13, 14 indicates the presence or absence of the lower run 4. The support element 7 is moved from its supporting position P1 into its retracted position P2 when one of the two sensor devices 13, 14 indicates the presence of the lower run 4 and the other of the two sensor devices 13, 14 indicates the absence of the lower run 4 and the signals from the two sensor devices 13, 14 thus do not match. This is shown in the upper half of the flow chart in FIG. 15. The pictogram depicted on the left in the upper half of FIG. 15 shows the position of the deflection arc 5 shown in FIG. 5 relative to the support unit 30 depicted as the second from the right in FIG. 5. As the associated FIG. 8 shows, both support elements 7 have been displaced from their supporting position P1 into their retracted position P2. The pictogram depicted on the right in the upper half of FIG. 15 shows the position of the deflection arc 5 relative to the support unit 30 depicted as the second on the right in FIGS. 5 and 6 in a position located between the positions shown in FIGS. 5 and 6.

The support element 7 is moved from its retracted position P2 into its supporting position P1 at least when both sensor devices 13, 14 indicate the presence of the lower run 4, or optionally even if both sensor devices 13, 14 indicate the absence of the lower run 4 and the signals from the two sensor devices 13, 14 thus match. This is shown in the lower half of the flow chart in FIG. 15. The pictogram depicted on the left in the lower half of FIG. 15 shows the position of the deflection arc 5 shown in FIG. 6 relative to the support unit 30 depicted as the second from the right in FIG. 6. As the associated FIG. 9 shows, both support elements 7 have been displaced from their retracted position P2 into their supporting position P1 in which the support element 7 can act as a support for the upper run 1 from below. The distance between the upper run 1 and running surface 9 shown in FIG. 9 depends on the pretensioning or internal stress of the energy guide chain 3, which means that the upper run 1 is only set down on the support elements 7 of this support unit 30 as the distance between the deflection arc 5 and the support unit 30 increases.

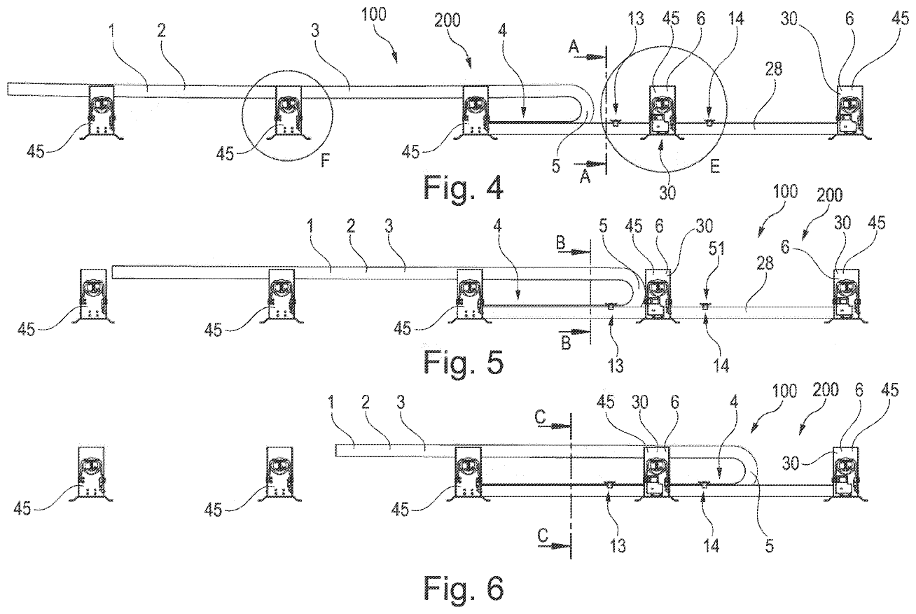

The pictogram depicted on the right in the lower half of FIG. 15 shows the position of the deflection arc 5 shown in FIG. 4 relative to the support unit 30 depicted as the second from the right in FIG. 4. As the associated FIG. 7 shows, both support elements 7 have been displaced from their retracted position P2 into their supporting position P1 in which the support element 7 can act as a support for the upper run 1 from below if an upper run 1 is or would be present.

This use or mode of operation of the system 100 can be carried out particularly simply and reliably. It can be terminated by a switch-off process 41.

In order to move the support element from its supporting position into its retracted position, the associated actuator 11 is driven by the control unit 16 by being supplied with electrical energy.

In order to move the support element from its retracted position P2 into its supporting position P1, the associated actuator 11 is driven by the control unit 16 by a supply of electrical energy to the associated actuator 11 being interrupted, such that the actuator 11 allows the support element 7 to be displaced from its retracted position P2 into its supporting position P1, preferably automatically by way of weight force and/or spring force.

The line-receiving apparatus 2 can be certified for cleanroom applications and/or is displaced at a speed of more than 5 m/s or 10 m/s or 15 m/s.

FIG. 16 to FIG. 18 in particular show an exemplary embodiment of the independently claimed spring support device 45.

The spring support device 45 is largely configured in the same way as the above-described support device 6, but in this case without an actuator and without interacting with a sensor device or a control unit. Two opposing spring support devices 45 are connected by way of a bottom crosspiece 31 to form a spring support unit 52. The spring support device 45 is used for temporarily supporting an upper run 1 of a line-receiving apparatus 2, for example of an energy guide chain 3, from below. The spring support device 45 comprises a support element 7 and two swivel arms 18 on which the support element 7 is arranged, wherein the support element 7 is displaceable between a supporting position P1 and a retracted position P2 (not shown in FIGS. 16 to 18) and the spring support device 45 has a passive displacement device 21 which comprises a switching device in the form of a switch body 22 which can be moved by way of spring force into the travel path of the line-receiving apparatus 2. The switch body 22 can be configured as described above in connection with the passive displacement device 21 of the system 100.

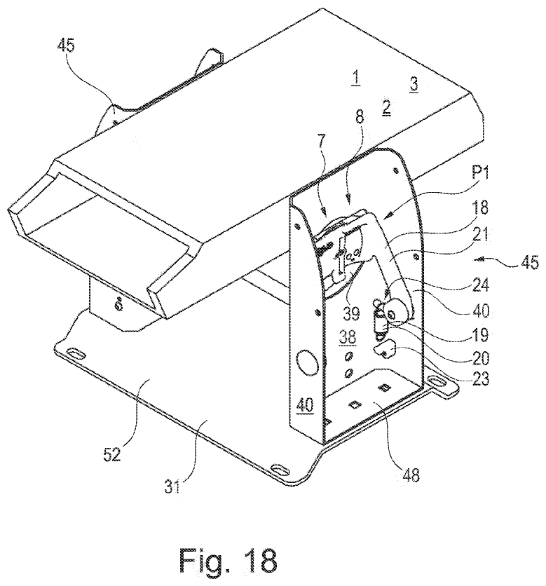

The spring force of the passive displacement device of the spring support device 45 is provided by a spring element 19 in the form of a helical spring 20, which acts between a spring bearing 23 of the spring support device 45 and a further swivel arm 24 which is firmly connected to the swivel arm 18. In FIGS. 16 and 18, the spring element 19 is not shown suspended in the spring bearing 23 for greater ease of depiction.

The swivel arm 18 and further swivel arm 24 together form an angle lever. The support element 7 of the spring support device 45 takes the form of a support roller 8 with a running surface 9.

The spring support device 45 has a load-bearing structure 12 for absorbing forces applied vertically downward from above by the upper run 1 onto the running surface 9.

FIGS. 1, 4 to 6 and 13 show spring support devices 45 which are arranged in regions where the deflection arc 5 cannot reach, for instance the three spring support devices 45 shown on the left in FIG. 4.

Supports with non-displaceable support elements can also be provided instead of these spring support devices 45.

### LIST OF REFERENCE SIGNS

100 System
200 Arrangement
1 Upper run
2 Line-receiving apparatus
3 Energy guide chain
4 Lower run
5 Deflection arc
6 Support device
7 Support element
8 Support roller
9 Running surface
10 Active displacement device
11 Actuator
12 Load-bearing structure
13 Sensor device
14 Sensor device
15 Detection range
16 Control unit
17 Assembly
18 Swivel arm
19 Spring element
20 Helical spring
21 Passive displacement device
22 Switch body
23 Spring bearing
24 Further swivel arm
25 Pivot bearing
26 Ball bearing
28 Side guide part
29 Coupling apparatus
30 Support unit
31 Bottom crosspiece
32 Run-on bevel
33 Rotary motor
34 Signal pathway
35 Holder
36 Axis of rotation of the support roller
37 Plane
38 Guide wall
39 Opening
40 Support walls
41 Switch-off process
42 Actuator input for receiving control signals
43 Control unit input for receiving sensor signals
44 Guide face
45 Spring support device
46 Swivel axis of the swivel arm
47 U-shaped cross-section
48 Bottom of the support device
49 Vertical sliding surface
50 Sliding bracket
51 Signal line
52 Spring support unit
L Longitudinal direction of the system or line-receiving apparatus
V Direction of displacement of the support element
P1 Supporting position
P2 Retracted position

What is claimed is:

1-26. (canceled)

27. A system for supporting an upper run of a line-receiving apparatus, in particular an energy guide chain, wherein:
the line-receiving apparatus is used for guiding at least one line, such as for example a cable, hose or the like, between a first connection point at a fixed point and a second connection point, which is mobile relative thereto, at a moving end, wherein the line-receiving apparatus has an upper run, and a lower run connectable to the first connection point, the upper run being connectable to the second connection point, and wherein the upper run and the lower run are connected to one another via a displaceable deflection arc, and wherein the line-receiving apparatus is displaceable along a travel path and, on displacement, the upper run runs above the lower run;
the system has at least one support device which comprises a support element for supporting the upper run from below and the support element has a support body with a sliding surface and/or a support roller with a running surface and the support element is displaceable between a supporting position, in which the support element can act as a support for the upper run from below, and a retracted position, in which the support element cannot act as a support for the upper run from below, wherein:
the support device comprises an active displacement device which has at least one controllable actuator for displacing the support element from the supporting position into the retracted position and/or vice versa and a coupling apparatus which couples the actuator to the support element and in that the system has at least one sensor device which interacts contactlessly with the line-receiving apparatus, and in that the system is configured to control the actuator as a function of sensor signals from the at least one contactlessly acting sensor device.

28. The system according to claim 27, wherein the sensor device comprises at least one proximity switch, such as for example an optical proximity switch, a light scanner, a capacitive proximity switch, a reed switching contact, a Hall-effect sensor or the like.

29. The system according to claim 27, wherein the system comprises at least one control unit for controlling the actuator as a function of the sensor signals, wherein each actuator is in particular associated with its own control unit.

30. The system according to claim 29, wherein the system is configured to be self-contained or operated in self-contained manner, in particular independently of sensor and/or control signals from a higher-level plant or machine controller, and the control unit is configured to receive sensor signals and is connectable or connected to sensor device.

31. The system according to claim 29, wherein the system comprises at least two sensor devices, wherein the control unit in each case interacts with two sensor devices which are arranged on different sides of an at least approximately vertical plane in which the direction of displacement of the support element is located.

32. The system according to claim 27, wherein, in addition to at least one sensor device, an identically constructed further sensor device is arranged on the same side of an at least approximately vertical plane in which the direction of displacement of the support element is located, wherein these two sensor devices, spatially separated from one another by the travel path of the line guide apparatus, are located opposite one another.

33. The system according to claim 27, wherein an assembly is provided which comprises a control unit and two sensor devices and a support device with an actuator, and the control unit is configured such that it controls the actuator exclusively as a function of the signals from the two sensor devices.

34. The system according to claim 27, wherein the actuator comprises an electrical drive, in particular rotary motor, preferably a stepping motor.

35. The system according to claim 27, wherein the support device has a load-bearing structure for absorbing forces applied vertically downward from above, in particular by the upper run, onto the sliding surface and/or the running surface.

36. The system according to claim 35, wherein the support device, in particular the load-bearing structure, has a vertically fixed guide wall and two support walls which form a U-shaped horizontal cross-section with the guide wall, and the actuator is arranged in the interior of this U-shaped cross-section, in particular is accessible “externally from the side”.

37. The system according to claim 36, wherein the support device comprises at least one swivel arm swivelably mounted by way of a pivot bearing, on which swivel arm the support element is arranged, wherein the swivel arm is operatively connected to the actuator for actuation of the swivel movement and wherein the swivel arm is swivelably mounted on the load-bearing structure in particular by way of the pivot bearing.

38. The system according to claim 37, wherein the pivot bearing comprises a ball bearing.

39. The system according to claim 37, wherein, in addition to the actuator, the displacement device comprises a spring element which acts contrary to the direction of a movement brought about by the actuator, wherein the spring element preferably comprises a helical spring which acts between a spring bearing of the support device and the swivel arm or a further swivel arm firmly connected to the swivel arm.

40. The system according to claim 27, wherein a passive displacement device is additionally provided which comprises a switching device in the form of a switch body which is movable into the travel path of the line-receiving apparatus, which switch body is configured to be capable of interacting mechanically with the deflection arc to displace the support element from the supporting position into the retracted position.

41. The system according to claim 40, wherein the switch body has in each case two opposing run-on surfaces, in particular run-on bevels, which can interact with the deflection arc, in particular in the event of failure of the active displacement device, in order to move the switch body out of the travel path of the line-receiving apparatus, wherein the switch body is coupled to the support element in such a way that the latter is movable from its supporting position into the retracted position and wherein the switch body is movable into the travel path of the line-receiving apparatus under the effect of gravity and/or by spring force.

42. The system according to o claim 27, wherein the system comprises at least one support unit which has precisely two opposing support devices.

43. The system according to claim 42, wherein at least two support units are provided and the system comprises two opposing side guide parts between which at least one of the runs can be received, and the two opposing side guide parts extend from one support unit to another support unit.

44. An arrangement with a system according to claim 27 and a line-receiving apparatus, wherein:
the line-receiving apparatus comprises an energy guide chain for guiding lines, such as for example cables or hoses, with two parallel strings of plates, wherein each string of plates comprises side plates which are connected to one another and bendable relative to one another by way of a flexible joint connector; or
the line-receiving apparatus comprises a band chain in which links or regions are connected to one another via a flexible band.

45. Use of a system according to claim 44, wherein the support element is displaced between a supporting position, in which the support element can act as a support for the upper run from below, and a retracted position, in which the support element cannot act as a support for the upper run from below without the deflection arc being mechanically contacted for this purpose.

46. The use of a system or an arrangement according to claim 45, wherein a sensor device is arranged on the side of the support element facing away from the first connection point and another sensor device is arranged on the side of the support element facing toward the first connection point,
and the signals from the two sensor devices are in each case evaluated as to whether the associated sensor device indicates the presence or absence of the lower run, and
the support element is displaced from its supporting position into its retracted position when one of the two sensor devices indicates the presence of the lower run and the other of the two sensor devices indicates the absence of the lower run, and
the support element is displaced from its retracted position into its supporting position when both sensor devices indicate the presence or the absence of the lower run.

47. The use of a system or an arrangement according to claim 45, wherein the system or the arrangement effects the displacement in self-contained manner, in particular independently of sensor and/or control signals from a higher-level plant or machine controller.

48. A spring support device for example for a system according to claim 27, for supporting an upper run of a line-receiving apparatus, in particular an energy guide chain, for guiding at least one line, such as for example a cable, hose or the like, between a first connection point at a fixed point and a second connection point at a moving end which is mobile relative thereto, wherein the line-receiving apparatus has the upper run, and a lower run which is connectable to the first connection point, the upper run being connectable to the second connection point and the upper run and the lower run being connected to one another via a displaceable deflection arc, and wherein the line-receiving apparatus is displaceable along a travel path and, on displacement, the upper run runs above the lower run, wherein the spring support device comprises a support element for supporting the upper run from below and at least one swivel arm on which the support element is arranged and the support element has a support body with a sliding surface and/or a support roller with a running surface and the support element is displaceable between a supporting position, in which the support element can act as a support for the upper run from below, and a retracted position, in which the support element cannot act as a support for the upper run from below, and the spring support device has a passive displacement device which comprises a switching device in the form of a switch body which is movable by way of spring force into the travel path of the line-receiving apparatus,
wherein
the spring force is provided by a spring element in the form of a helical spring which acts between a spring bearing of the spring support device and the swivel arm or a further swivel arm firmly connected to the swivel arm.

49. The spring support device according to claim 48, wherein the spring element acts between a spring bearing of the spring support device and a further swivel arm firmly connected to the swivel arm, wherein the further swivel arm provides a lever projection to create a leverage effect for the spring element and the swivel arm and the further swivel arm together form an angle lever.

50. The spring support device according to claim 48, wherein the spring element is hooked into the spring bearing.

51. The spring support device according to claim 48, wherein the spring support device has two swivel arms and two spring elements.

52. The spring support device according to claim 48, wherein the spring element is arranged in an opening of the spring support device which is accessible externally from the side.
